(19) United States
(12) Patent Application Publication
(10) Pub. No.: US 2015/0240654 A1
(43) Pub. Date: Aug. 27, 2015

(54) SOLAR POWER AND LIQUID AIR ENERGY STORAGE SYSTEMS, METHODS, AND DEVICES

(71) Applicant: MADA Energie LLC, New York, NY (US)

(72) Inventor: Arnold J. GOLDMAN, Jerusalem (IL)

(21) Appl. No.: 14/559,882

(22) Filed: Dec. 3, 2014

Related U.S. Application Data
(60) Provisional application No. 61/911,282, filed on Dec. 3, 2013.

(51) Int. Cl. F01D 15/10; F01K 15/00; F01K 13/00; H02J 3/32; F01K 3/18; F03G 6/00; H02J 3/28; F01K 25/08; F01K 3/00

(52) U.S. Cl. CPC F01D 15/10; F01K 25/08; F01K 15/00; F01K 13/00; F01K 3/004; F01K 3/186; F03G 6/00; F03G 6/001; H02J 3/28; H02J 3/32

(57) ABSTRACT

A solar energy production and storage apparatus includes an energy storage unit, a solar photovoltaic (PV) unit, a solar thermal unit, and a high temperature thermal storage unit. The energy storage unit can be a Liquid Air Energy Storage (LAES) unit which can include an electrical energy input, an electrical energy output, and one or more conduits to transfer at least one of thermal energy and working fluid between the LAES unit and the high temperature thermal storage unit. The solar PV unit can produce electrical energy and can include an electrical energy output. The solar thermal unit can produce thermal energy, the solar thermal unit comprising a thermal energy output. The high temperature thermal storage unit can include a thermal energy input and one or more conduits to transfer at least one of thermal energy and working fluid between the LAES unit and the high temperature thermal storage unit.

### CROSS REFERENCE TO RELATED APPLICATIONS

The present application claims the benefit of U.S. Provisional Application No. 61/911,282, filed Dec. 3, 2013, which is hereby incorporated by reference herein in its entirety.

### FIELD AND BACKGROUND

Embodiments relate generally to the field of electrical energy and power, and more specifically to energy generation, conservation and/or displacement where solar may generate all or a portion of the electrical energy and a significant portion of the storage capacity may be achieved by a Liquid Air Energy Storage (LAES).

There may be a growing desire in specific regions to increase the renewable energy capacity. Specific places such as California may set goals for the amount of power that should be generated from renewables. Some of the candidates that are being proposed and highlighted to meet these goals are energy sources such as wind and solar energy. There may be a variety of reasons for the desire to generate more power from renewables. However, renewable sources may face some challenges that may raise hurdles in the process of meeting desired goals that are set.

### SUMMARY

In one or more embodiments, a solar energy production and storage apparatus includes an energy storage unit, a solar photovoltaic (PV) unit, a solar thermal unit, and a high temperature thermal storage unit. The energy storage unit can be a Liquid Air Energy Storage (LAES) unit. The LAES unit can include an electrical energy input, an electrical energy output, and one or more conduits to transfer at least one of thermal energy and working fluid between the LAES unit and the high temperature thermal storage unit. The solar PV unit can produce electrical energy and can include an electrical energy output. The solar thermal unit can produce thermal energy, the solar thermal unit comprising a thermal energy output. The high temperature thermal storage unit can include a thermal energy input and one or more conduits to transfer at least one of thermal energy and working fluid between the LAES unit and the high temperature thermal storage unit. In some embodiments, the solar energy production and storage apparatus can also include a battery. The batter unit can include an electrical energy input and an electrical energy output.

In one or more embodiments, a solar energy production and storage system includes a solar photovoltaic (PV) unit, a solar thermal unit, a Liquid Air Energy Storage (LAES) unit, an external high temperature storage unit, and a controller. The solar PV unit can produce electrical energy and can be coupled to an energy consumer to provide electrical energy to energy consumer. The LAES unit can be coupled to the energy consumer to provide electrical energy to the energy consumer. The high temperature thermal storage unit can be coupled to the LAES unit to transfer thermal energy to the LAES unit. The solar thermal unit can produce thermal energy and can be coupled to the high temperature thermal storage unit to transfer thermal energy to the high temperature thermal storage unit 406. The high temperature thermal storage unit can store the thermal energy received from the solar thermal unit and/or pass the thermal energy received from the solar thermal unit to the LAES unit to thermally charge the LAES unit and/or to improve electrical dispatch performance of the LAES unit. The solar PV unit and the LAES unit can each be coupled to the energy consumer to provide stabilized solar-LAES energy to the energy consumer. The controller can be configured to stabilize the electrical capacity of energy generation available to the energy consumer by causing the LAES unit to dispatch electrical energy to the consumer from the LAES unit during periods of under capacity and to draw down electrical energy to the LAES unit during periods of over capacity.

In one or more embodiments, a solar energy production and storage system includes an energy storage unit including a Liquid Air Energy Storage (LAES) unit, a high temperature thermal storage unit, and a thermal energy input. The LAES unit can include an electrical energy input, an electrical energy output, and one or more conduits to transfer at least one of thermal energy and working fluid between the LAES unit and the high temperature thermal storage unit. The high temperature thermal storage unit can include a thermal energy input connected to receive power from a non-dispatchable source of electrical power. The thermal energy input can be connected to a non-dispatchable source of thermal power. The thermal energy input can be connected to the high temperature thermal storage unit to store thermal energy in the high temperature thermal storage unit. The thermal energy in the high temperature thermal storage unit can be connected in the LAES to raise a working fluid temperature to generate electrical power at the electrical energy output.

### BRIEF DISCRIPTION OF THE DRAWINGS

Embodiments will hereinafter be described with reference to the accompanying drawings, which have not necessarily been drawn to scale. Where applicable, some features may not be illustrated to assist in the illustration and description of underlying features.

Throughout the figures, like reference numerals denote like elements. As used herein, various embodiments can mean one, some, or all embodiments.

FIG. 1 illustrates a Liquid Air Energy Storage (LAES) with an external thermal energy storage unit, in accordance with an embodiment.

FIG. 2 illustrates a facility 100 containing multiple components operating in conjunction, the components including a photovoltaic (PV) apparatus, a thermal energy solar apparatus, an external high temperature storage unit, and a LAES, in accordance with an embodiment.

FIG. 3 illustrates a facility containing multiple components operating in conjunction, the components including a photovoltaic (PV) apparatus, a thermal energy solar apparatus, a

LAES, an external high temperature storage unit, and a battery, in accordance with an embodiment.

FIG. 4 illustrates a solar energy production and storage system, in accordance with an embodiment.

### DETAILED DESCRIPTION

There may be a number of issues with regard to solar energy that may present challenges for electrical energy generation, conservation, and/or displacement. Some of these issues may be related to solar power availability, stability and/or cost, in addition to the issue of time and/or capacity of delivery.

Issues of availability may arise due to the availability of the sun, which is not available during the night. In addition to the availability of the sun only during the day, availability is also often affected due to other reasons such as cloudiness. For example, cloudy days may be disruptive for the generation of electrical energy generated from solar energy facilities. In addition, the sun may be available during periods of time when the power generated is not needed and/or desired.

Issues of stability may arise due to the instability of the sun's insulation. For example, the stability of the sun's insulation may be disrupted due to many causes such as night, clouds, etc. These disruptions may cause a reduction of the power generated by the solar facilities and/or a disruptive output of energy such as intermittent energy output.

Issues of cost may arise due to higher cost requirements of solar facilities in relation to other facilities such as coal power plants, gas plants etc. Utilization may be another parameter to measure cost. Whereas facilities such as coal or nuclear plants etc. are entitled to operate as base load plants, which may be due to the non-flexible nature of these plants (other reasons may exist). It may be the case that plants such as coal, nuclear etc. may operate 100 percent of the time (or near 100% of the time) thus reducing the cost of the facility (from the perspective of return on investment, or the amount of time required to generate a return of the investment).

Issues of time and energy delivery may arise during periods that solar is available, however not desired (as stated above). And may further arise during periods when the grid is saturated with electrical energy, and there is no desire for further amount of energy. This state may occur during periods of high sun insulation whereas a large amount of solar power is added to the electrical grid, and there may not be a desire for the whole amount of power.

Some embodiments comprise a facility (or system) containing multiple components including a Photovoltaic (PV) solar apparatus, a thermal solar energy apparatus, and a Liquid Air Energy Storage (LAES) apparatus operating in conjunction. In such embodiments, the PV apparatus may dispatch electrical energy to the electrical grid (or any other consumer) or may charge the LAES. The thermal solar energy apparatus's high temperature thermal energy may be directed to thermally charge the LAES. The LAES may be charged both thermally and electrically, and may dispatch electrical energy to the electrical grid (or any other consumer) during the discharge cycle.

The Liquid Air Energy Storage (LAES) apparatus may be an apparatus that may be charged during one period of time and may be discharged during a second period of time. The LAES may be charged by electrical energy (electrical charge) and/or by thermal energy (thermal charge). The LAES may be charged both electrically and thermally during the same period of time, or during separate periods of time. During the electrical charge the LAES apparatus may convert electrical energy to thermal energy, and store the thermal energy for later use. During the discharge cycle the LAES may convert the thermal energy stored in the LAES to electrical energy. During the thermal charge the LAES may absorb and store thermal energy generated from an external source that may be utilized at a later period of the discharge cycle

Thermal energy stored in the LAES may have a range of temperatures. The LAES may convert electrical energy to thermal energy at a range of high temperatures and range of low temperatures. Different ranges of temperatures may be stored in suitable substances and vessels for a short or prolonged period of time as known to one who is skilled in the art. When the LAES is operating in an electrical charging mode (charging cycle), it can generate liquid air and store liquid air that has been generated. Generating liquid air may be achieved by assembling devices, apparatuses, flow directions etc. that working together may generate liquid air. Some devices, for example, may be compressor/s, motor/s etc. During periods of time when the LAES is operating in charge mode, the LAES may draw down electrical energy from any electrical energy source and power a motor (one or more) and drive a compressor (one or more). The compressor may trap and compress air from the environment into the LAES. The compressed air may rise in pressure and temperature. The high temperature may be extracted from the air and stored in a thermal energy storage unit. Compressing the air and extracting the high temperature thermal energy from the air may be done once or more. The now compressed and cooled down air (air stream) may be further processed in order to achieve liquefaction. Further processing of the air may involve directing the air through one or more heat exchangers in order to further reduce the temperature of the air stream. The air stream, or part of it, may be processed through apparatuses such as refrigeration apparatuses (or any other apparatus resulting in a reduction of the air stream's temperature). The air stream may be directed through a device such as an expander (or other means or apparatuses) that may reduce the pressure and temperature of the air stream. The air stream at the outlet of the expansion device may be liquefied. A portion of the air stream may be liquefied and the rest of the air stream may remain in a gaseous form. When some air remains in gaseous form, the air which remained in a gas form may be directed through one or more heat exchangers, exchanging thermal energy with the air stream compressed through the LAES, thus reducing the air stream's temperature, prior to exiting the LAES. Air stream which has transformed to liquid may be stored in a liquid air storage unit. At the end of the electrical charging process it may be the case that the LAES may contain liquid air in a liquid air storage unit, and high temperature (or relatively high temperature) may be stored in high temperature thermal energy storage units.

In some embodiments, the LAES may be charged from a thermal energy source. The thermal energy source may be any high temperature thermal energy generator such as a thermal solar energy apparatus. In some embodiments, a suitable high temperature material will receive and contain the high temperature thermal energy that was generated. The high temperature material may be directed through a heat exchanger (or other means) and receive the high temperature thermal energy. The material may then be directed and stored in a storage vessel known to one who is skilled in the art. The material may be later utilized during the discharge cycle. In some embodiments, the material may be heated (charged) by an electrical means such as heating coils. During periods with limited sun insulation, which may result in limited charging ability from the thermal solar energy apparatus, the thermal charge cycle may be achieved by powering heating coils from the electrical grid (or any other generator), powering the said heating coils, charging the said suitable material and storing the material in the said storage devices.

In some embodiments, the LAES may have multiple storage units which may be located in different areas. One area may be referred to as the cold-hot storage. The cold-hot storage area may contain the multiple storage units that are being charged (and discharged) from and during the electrical charging cycle. A second area that may be referred to as the external thermal storage (heat cap) may contain the thermal storage units that are being charged (and discharged) from and during the thermal charging cycle. In some embodiments, the temperature stored within the heat cap is higher than that stored in the high temperature storage vessels of the cold-hot area.

In some embodiments, the LAES may be operated during a second period of time in discharge mode. In such mode of operation, liquid air may be pumped throughout the LAES apparatus. Whereas a liquid pump may pump liquid air from the liquid air storage, through the different thermal energy storages of the cold-hot area (or other thermal energy storages, or thermal energy locations). During this process the liquid air may exchange high thermal energy that is stored in the storage units (or receive high thermal energy from different locations) and emit low thermal energy to the storage units that may be stored for later use (i.e., during the charging cycle as a means of reducing the temperature of the air stream). The liquid air which has been pumped at desired pressures, and received high temperature thermal energy contained in the cold-hot area may be directed to the heat cap. In some embodiments, the air may flow through a heat exchanger and receive the high temperature contained in the heat cap (in the said material stored in the heat cap). It may be the case that the air will then be directed through a turbine that may drive a generator, and generate electrical energy that may be dispatched.

Some embodiments comprise a facility containing multiple apparatuses including a photovoltaic (PV) apparatus, a thermal energy solar apparatus, and a LAES apparatus, operating in conjunction. The PV apparatus may generate electrical energy during periods of time when there is available sun insulation. The generated electrical energy may be dispatched to the electrical grid (or other consumers), or may be dispatched and stored to and within the LAES. It also may be the case that a portion of the electrical energy may be dispatched to the electrical grid and a second portion may be dispatched to the LAES. The thermal solar energy apparatus can generate high temperature thermal energy during periods of time when there is available sun insulation. This may be achieved by a variety of methods such as troughs, solar towers etc. as known to one who is skilled in the art. The high temperature heat generated may be transferred to a suitable material that may be stored in the external thermal storage of the LAES. The LAES may be charged both electrically and thermally. Charging the LAES electrically may be achieved by consuming electrical energy that is generated from the PV apparatus. Furthermore, the LAES may be charged by drawing down electrical energy from the electrical grid (or any other electrical source). Charging the

LAES thermally may be achieved by storing the high temperature generated by the thermal solar energy apparatus and/or by powering the heating coils. Charging the LAES electrically may result (as detailed above) in the generation and the storage of both high temperature thermal energy (contained in the high temperature storage units of the cold-hot area), and of low temperature thermal energy (contained in the low temperature storage units of the cold-hot area) and generation of liquid air that may be stored in a liquid air storage unit. Charging the LAES thermally may result (as described above), in charging the external thermal storage units of the LAES. Generating electrical energy from the LAES (i.e. discharging the LAES) may occur during a period of time when the PV apparatus is dispatching to the grid and/or during a period of time when the PV apparatus is not dispatching electrical energy to the grid.

In some embodiments, the LAES apparatus may not store the high temperature generated and extracted from the compressed air. In some such embodiments, if the high temperature of compressed air is not stored, it may be vented out to the environment. In some embodiments, during the discharge cycle pumped liquid air would be directed only to the external thermal storage unit (i.e., there may not be high temperature thermal storage units in the cold-hot area).

Some embodiments are configured to operate in such a way as to dispatch electrical energy when desired as desired. The facility may dispatch electrical energy from the PV apparatus and from the LAES apparatus together, separately, or not dispatch electrical energy at all. During periods of time when there is available sun insulation, but the desire for electrical energy is low (e.g., low consumption of electrical energy) that the PV apparatus electrical output may be dispatched and consumed by the LAES. Periods of such nature may be periods of time such as weekend days where the electrical consumption is low (however the sun insulation is unaffected). According to one embodiment the facility may be configured to direct the electrical output of the PV apparatus to charge the LAES. The LAES may electrically charge the storage units associated with the electrical charge storage units. It may be the case that the stored energy may then be dispatched during a later period when it is desired, for example during the weekdays (day and/or night). There may other periods of time of such nature; for example holiday days, early hours of the day when the sun's insulation is available while consumption is low etc.

A facility that may dispatch electrical energy during the night as well as during the day may be advantageous. In some embodiments, the facility may dispatch electrical energy during the daytime by directing the PV apparatus' electrical output to the electrical grid, with or without dispatching electrical energy from the LAES. During the night, electrical energy may be dispatched from the LAES. In such a case it may be that the LAES may be charged from either a partial load of the PV apparatus output (the LAES may or may not be dispatch electrical energy during this period of time), or from any other electrical source (prior to dispatching). In some such embodiments, the LAES can dispatch electrical energy during the night. Thus the facility may operate during day and night hours. In some embodiments, the LAES may provide available power for more than 4 hours (or any other desired number of hours). Therefore, it may be that the facility can qualify to be a reliable power source, thus adding value to the facility.

The solar thermal apparatus may differ from a traditional Concentrated Solar Power CSP with respect to a number of aspects. One of these may be that the solar thermal apparatus used in the facility may be constructed without a power block. It may be the case that the cost of the power block in a traditional CSP is relatively high (i.e. a significant percent of the cost of the facility). It may be the case that in the detailed facility the solar thermal apparatus will not have a power block. This may be achieved due to the consumption and the storage of the thermal energy generated from the solar thermal apparatus within the external heat storage of the LAES, and the later usage of the thermal energy during the discharge cycle of LAES (i.e. with the equipment, devices, materials etc. of the LAES). It may be the case that supplementing the power block of a CSP with a LAES will not increase the cost of the overall facility by a significant amount (whereas significant may be understood as a percentage of the overall cost of the facility) and/or the increase in price may be valued as smaller than the increase in the value of the apparatus. It further may be the case that the efficiency of the solar thermal apparatus may be relatively higher than a traditional CSP due to the low temperature of the working fluid of the LAES (i.e. cryogenic liquid air) being closer to the vicinity of absolute zero. Versus the traditional working fluid which may be in the vicinity of ambient temperature, as known to one who is skilled in the art. It further may be the case that a traditional CSP may generate electrical energy via rotating turbo machinery which may be connected to an electrical generator. This may be the same scheme as LAES that may generate electrical energy by rotating turbo machinery which may be connected to an electrical generator. This similarity may (but not necessary) play a role in regards to considerations such as permitting etc.

Photovoltaic (PV) cells (module, facility etc.) may suffer from a drop in the efficiency due to high temperatures within the PV cells. For example, as the PV cell is exposed to the sun and as the temperature of the cell increases, the output efficiency of the PV cell can decrease. In some embodiments, a portion of the cold capacity generated, stored and/or utilized within the LAES may be directed towards the PV apparatus. The directed cold capacity may reduce the temperature of the PV cells of the PV apparatus, thereby increasing the efficiency of the PV apparatus.

Solar power may face stability issues (i.e., the output electrical energy may be characteristically intermittent). The intermittent electrical energy may be of high frequency or low frequency. The meaning of high frequency is frequent shifts in the output capacity (the rate of change is high). And the meaning of low frequency is non frequent shifts in the output capacity (the rate of change is low). A storage unit may operate as a regulator to the intermittent output of the electrical energy. In some embodiments, an energy storage unit may operate to negate the intermittent output energy by meeting the output energy in a mode of operation that regulates the output energy of the solar energy generator. For example, drawing down (charging) during periods of overcapacity generation, dispatching (discharging) during periods of under capacity generation and standing by during periods of desired generation. It may be the case that low frequency intermittent energy output may need to be met by a large capacity energy storage system, due to the relative prolonged period of time of either under capacity or overcapacity generation of the solar electrical energy facility.

It may be desirable to meet high frequency intermittent output by a fast responding storage facility. This may be due to the high speed at which the output energy from the solar energy generator may shift. The LAES may meet low frequency intermittency due to the large capacity that the LAES may store/generate. However, the LAES may not be suitable to regulate high frequency intermittency due to the ramping time associated with the rotating equipment of the LAES. Rotating equipment may be devices such as a motor/s, compressor/s, expander/s (turbine/s), generator/s etc.

Some embodiments include multiple apparatuses such as a PV apparatus, a thermal energy solar apparatus, a LAES apparatus, and a battery operating in conjunction to meet high frequency intermittency. In such embodiments, when the facility is desired for fast responding (whether it is during the charging mode or the discharging mode) the battery may be the first to respond. The battery can respond as desired for the length of time in which the rotating equipment of the LAES may ramp up to operate at (or near) full load (or partial load). When the LAES is operating at (or near) full load (or partial load) the battery may shift to standby mode. The battery may charge and may discharge electrical energy from/to the grid, and/or from/to the facility (or any other generator or consumer).

In some embodiments, the capacity of the battery can be relatively small (relative to the overall capacity of the facility). This may be due to the desired battery capacity for the ramping period of time of the LAES' rotating equipment. The additional cost of the battery may be relatively small (as a percentage of the cost of the facility) because of the relatively small capacity of the battery. The facility may respond with a response time of a battery and may respond with a capacity of a LAES as known to one who is skilled in the art. The battery and the battery operation may be configured to optimally operate the battery with considerations such as, for example: battery life cycle (a consideration that may increase the capacity size of the battery, in order to achieve a prolonged use of the battery, due to a partial load charge/discharge cycle and not a full load cycle) battery operation (with regard to the charge load of the battery during standby mode, and charge rates at the end of each operation mode).

As disclosed, embodiments may generate regulated and stable solar energy and may operate to regulate and stabilize the electrical grid capacity (e.g., by dispatching electrical energy during periods of under capacity and drawing down electrical energy from the grid during periods of time of overcapacity).

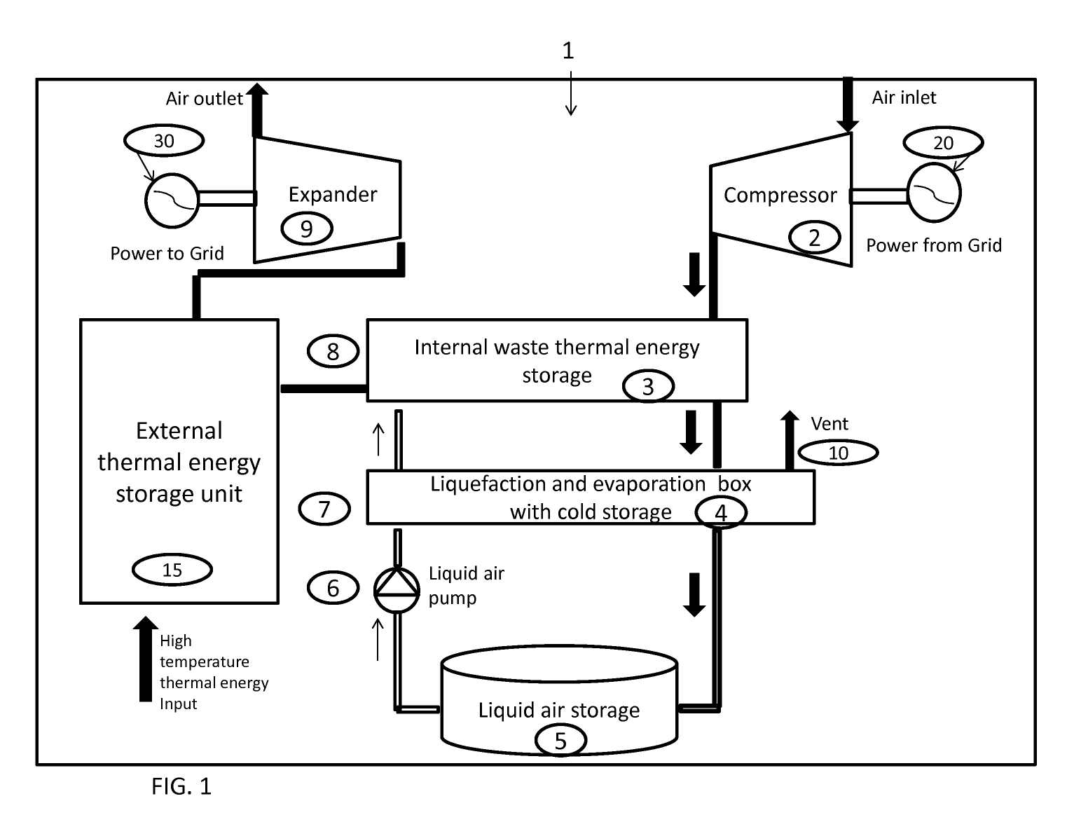

FIG. 1 illustrates a Liquid Air Energy Storage (LAES) 1 with an external thermal energy storage unit 15, in accordance with an embodiment. LAES 1 may operate in a few modes of operation. In one mode of operation LAES 1 may draw down electrical energy from any electrical source, convert the electrical energy to both high and low thermal energy temperatures (this mode will be referred to as the electrical charging cycle). LAES 1 may also be charged by absorbing and storing thermal energy within an external thermal energy storage unit (this mode will be referred to as the thermal charging cycle). During a second period of time LAES 1 may convert thermal energy stored in LAES 1 to electrical energy that may be dispatched to the electrical grid (this mode will be referred to as the discharge cycle).

LAES 1 may operate in an electrical charging mode. During the charging mode electrical energy may be drawn down from any electrical energy source to power a motor 20 (or motors indicated by motor 20) that may drive a compressor 2 (or compressors indicated by compressor 2). The compressor 2 may trap air from the environment into LAES 1. The compressed air temperature and pressure may rise as a result of the compression. High thermal energy may be extracted from the air and stored in internal waste thermal energy storage 3. The air stream may be directed to be further processed in order to liquefy the air stream. Further liquefaction may be a result of means and apparatuses such as: directing the air stream through cold storages units, further refrigeration devices (or apparatuses that resemble or operate as refrigeration devices), expanding the air through an expansion device (expansion chamber, expansion turbine, throttle device etc.).

In some embodiments, the apparatuses such as cold storages units, further refrigeration devices (or apparatuses that resemble or operate as refrigeration devices), expansion devices (throttle device, expansion turbine, expansion chamber etc.) may be located in or associated to the liquefaction and evaporation box with cold storage 4. The air stream exiting the liquefaction and evaporation box with cold storage 4 may be liquefied. Liquid air may then be stored in liquid air storage 5.

In some embodiments, a portion of the air stream will remain in a gaseous form. In some such embodiments, the air stream which has remained in a gaseous form can be directed through the liquefaction and evaporation box with cold storage 4, in order to utilize the cold capacity contained in the said stream. The air stream that has been redirected through the liquefaction and evaporation box with cold storage 4 may be vented out by vent 10 after exchanging thermal energy with the air stream that may be processed for liquefaction. LAES 1 may be charged thermally. Charging LAES 1 thermally may be achieved by absorbing and storing a high temperature thermal energy input. The high temperature thermal energy may be contained within a suitable material such as (but not limited to) a molten salt, or other suitable materials known to one who is skilled in the art. The said suitable material may be stored for a short or prolonged period of time in external thermal energy storage unit 15 to be utilized during the discharge cycle. The temperature stored in the external thermal energy storage unit 15 may be higher than the thermal temperature stored within the internal waste thermal energy storage 3.

It may be the case that LAES 1 may operate in a discharge mode. In such a mode, a liquid air pump 6 may pump liquid air from the liquid air storage unit 5, through LAES 1 at a desired/predetermined pressure. The liquid air may be processed in liquefaction and evaporation box with cold storage 7 (whereas the number change is indicative of the two modes of charge and discharge). During this process it may be the case that the liquid air stream may exchange thermal energy with a concurrent air stream which is cooled down. The pumped air stream exits the liquefaction and evaporation box with cold storage 7 and is directed to the internal waste thermal energy storage 8 (whereas the number change is indicative of the two modes of charge and discharge). In the internal waste thermal energy storage 8, the pumped liquid air stream (now in a gaseous form after evaporation) further exchanges thermal energy with the incoming air. During this process, the air stream may exchange relatively low temperature thermal energy (relative to the thermal energy contained in the waste thermal energy storages units) with relatively high temperature thermal energy contained in the substances of the internal waste thermal energy storage 8. In some embodiments, relatively low temperature thermal energy that has been extracted from the liquid air may be stored in the internal waste thermal energy storage for use during the charging cycle. The air stream exiting the internal waste thermal energy storage 8, may be directed to external thermal energy storage unit 15. In some embodiments, the air will receive further high temperature thermal energy that has been stored in external thermal energy storage unit 15. Air exiting external thermal energy storage unit 15 may be directed to drive a turbine (air expander) 9, which may operate (power) a generator 30 that may generate electrical energy.

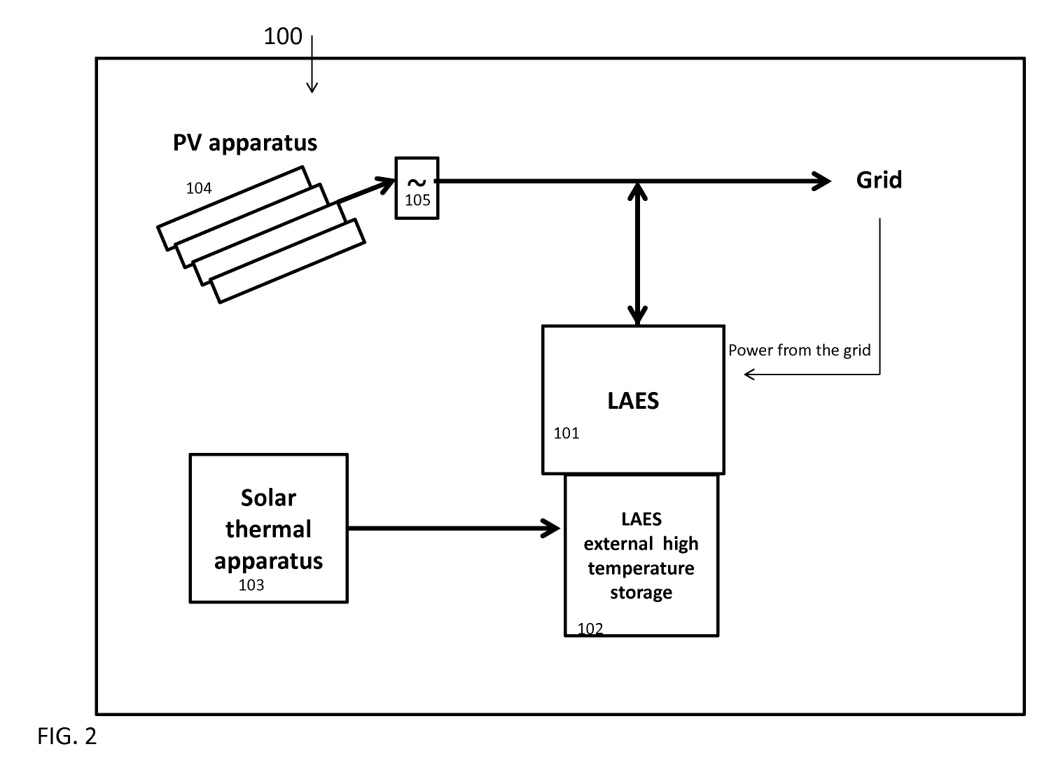

FIG. 2 illustrates a facility 100 containing multiple components operating in conjunction, the components including a photovoltaic (PV) apparatus 104, a thermal energy solar apparatus (or “solar thermal apparatus”) 103, an external high temperature storage unit 102, and a LAES 101, in accordance with an embodiment. PV apparatus 104 may dispatch electrical energy to either the grid or to the LAES 101 (or any other consumer). The electrical output may be directed through a converter 105. High temperature thermal energy that is generated by the solar thermal apparatus 103 may be absorbed and stored in an external high temperature energy storage 102 associated with the LAES apparatus 101.

In some embodiments, the LAES apparatus 101, in conjunction with the external high temperature energy storage 102, may be discharged to generate electrical energy as discussed above. In some embodiments, the electrical energy generated by the LAES apparatus 101 in conjunction with the external high temperature energy storage 102 may be dispatched to the grid (or any other consumer).

The LAES apparatus 101 may operate in a number of modes of operation including, for example, a charging mode, a discharging mode, and a standby mode (neither charge nor discharge). The charging of the LAES 101 may be executed either electrically or thermally (or both). In some embodiments, charging the LAES 101 thermally may be achieved as stated above. In some embodiments, charging the LAES 101 electrically may be achieved by the LAES 101 drawing down electrical energy from the PV apparatus 104 or by drawing down electrical energy from the grid (or any other generator).

In some embodiments, a portion of the cold capacity generated, utilized, or stored within the LAES 101 may be directed to cool down the PV cell (not shown) of the PV apparatus 104. In some embodiments, the cold capacity extracted from multiple sources within the LAES 101 (e.g., liquid air storage 5, cold storage within the liquefaction and evaporation box with cold storage 4, the air vent 10, etc.). In some embodiments, the PV apparatus 104 may operate with higher efficiency, as a result of cooling down the PV cells.

In some embodiments, facility 100 may contain heating coils. The heating coils may be located within the external high temperature storage 102 (not shown), or any other suitable location. The heating coils may be powered from the electrical grid (or any other electrical generator). If there is a desire for further increasing the temperature of the material located and stored within external high temperature storage 102, it may be achievable via the heating coils.

Facility 100 may be desired for fast response. LAES 101 may have a ramping time due to the rotating equipment contained within the LAES 101. Rotating equipment may include equipment such as, for example, motor/s 20, compressor/s 2, expander/s 9, and generator/s 30. The rotating equipment may ramp to full load, thus preventing apparatus 100 from responding quickly.

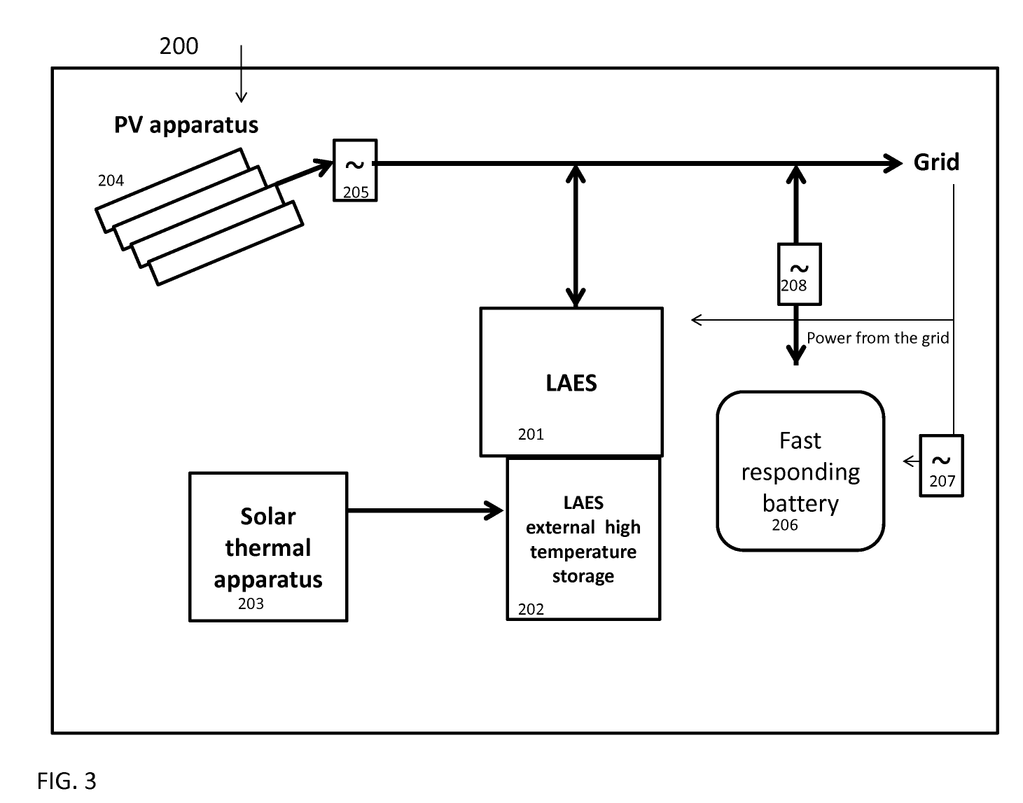

FIG. 3 illustrates a facility containing multiple components operating in conjunction, the components including a photovoltaic (PV) apparatus 204, a thermal energy solar apparatus (or “solar thermal apparatus”) 203, an external high temperature storage unit 202, a LAES 201, and a battery (or “fast responding battery”) 206, in accordance with an embodiment. PV apparatus 204 may dispatch electrical energy to the grid, to the LAES 201, and/or to the battery 206 (and/or any other consumer). The electrical output may go through a converter 205. High temperature thermal energy that is generated by the solar thermal apparatus 203 may be absorbed and stored in an external high temperature energy storage 202 associated with the LAES apparatus 201. The LAES apparatus 201, in conjunction with the external high temperature energy storage 202, may be discharged to generate electrical energy as described above. The electrical energy generated by the LAES apparatus 201 in conjunction with the external high temperature energy storage 202 may be dispatched to the grid and/or to the battery 206 (and/or any other consumer). The the battery 206 may be a fast responding electrical storage unit.

The battery 206 can be charged and discharged. Charging the battery may be achieved by an electrical source such as the PV apparatus 204, the LAES 201, and/or the electrical grid (and/or any other electrical source). The battery 206 may be dispatched to the LAES 201 or to the electrical grid. During charging or discharging the battery 206, there may be a desire for a converter indicated in the drawings by converters 207, 208.

When fast response is desired, the first apparatus to respond may be the fast responding battery 206. In some embodiments, the LAES 201 will ramp to (or near) full load. When LAES 201 is operating at full (or near full) load, the battery 206 can shift to standby mode. Facility 200 can dispatch stable, reliable electrical energy. PV apparatus 204 can dispatch electrical energy to the electrical grid. In some embodiments, when the sun's insulation is unstable and the PV apparatus 204 is dispatching intermittent electrical energy, the battery 204 in conjunction with the LAES 201 may operate to negate such intermittency. If the intermittency is high frequency intermittency (as described above) the battery 206 can respond fast, followed by the LAES 201. In some embodiments, facility 200 can provide auxiliary services such as stabilization, regulation, fast ramping, load following etc. for the electrical grid (i.e., desired auxiliary services for electrical sources external to facility 200, such as the electrical grid).

The LAES 201 apparatus may operate in a number of modes as described above with respect to LAES 1 and LAES 101 shown in FIGS. 1 and 2, respectively.

Both facilities 100 and 200 discussed above and system 400 discussed below may be regarded as a solar facility. Both facilities 100 and 200 and system 400 may be regarded as a storage facility.

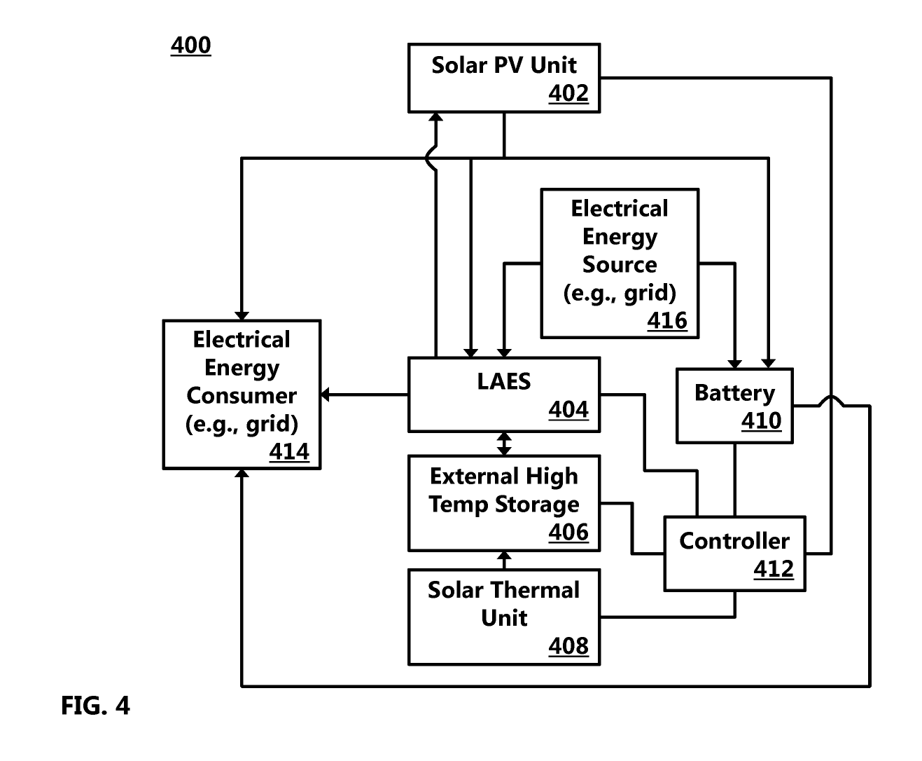

FIG. 4 illustrates a solar energy production and storage system 400, in accordance with an embodiment. System 400 can include a solar photovoltaic (PV) unit 402, a solar thermal unit 408, a Liquid Air Energy Storage (LAES) 404, an external high temperature storage unit 406, a battery (or “fast responding battery”) 410, a controller 412, an electrical energy consumer 414, and an electrical energy source 416. Solar PV unit 402 can produce electrical energy and can be coupled to energy consumer 414 to provide electrical energy to energy consumer 414. LAES unit 404 can be coupled to energy consumer 414 to provide electrical energy to the energy consumer. High temperature thermal storage unit 406 can be coupled to LAES unit 404 to transfer thermal energy to LAES unit 404. Solar thermal unit 408 can produce thermal energy and can be coupled to high temperature thermal storage unit 406 to transfer thermal energy to high temperature thermal storage unit 406. High temperature thermal storage unit 406 can store the thermal energy received from solar thermal unit 408 and/or pass the thermal energy received from solar thermal unit 408 to LAES unit 404 to thermally charge LAES unit 404 and/or to improve electrical dispatch performance of LAES unit 404. Solar PV unit 402 and LAES unit 404 can each be coupled to energy consumer 414 to provide stabilized solar-LAES energy to energy consumer 414. Controller 412 can be configured to stabilize the electrical capacity of energy generation available to the energy consumer by causing LAES unit 404 to dispatch electrical energy to consumer 414 from LAES unit 404 during periods of under capacity and to draw down electrical energy to LAES unit 414 during periods of over capacity. LAES unit 404 can be coupled to energy source 416 to draw down electrical energy to LAES unit 404 from energy source 416. In some embodiments, energy consumer 414 and energy source 416 are the same (e.g., the electric grid).

Battery 410 can provide fast response electrical energy to energy consumer 414 while LAES unit 404 ramps to a predetermined load. Battery 410 can enter standby when LAES unit 404 has reached the predetermined load. In some embodiments, the predetermined load is substantially the full load of LAES unit 404.

LAES unit 404 can transfer cold capacity to solar PV unit 402. Solar PV unit 402 can comprise a PV cell (not shown) that is cooled down by the cold capacity of LAES unit 404 to increase the operating efficiency of solar PV unit 402.

In some embodiments, energy consumer 414 is an electric grid. In some such embodiments, energy source 414 is the same electric grid.

In some embodiments, LAES unit 404 is coupled to solar PV unit 402 such that the LAES unit receives electrical energy generated by the solar PV unit that is not transferred via the electric grid (e.g., consumer 414 and source 416).

LAES unit 404 may operate in a number of modes such as those described above with respect to LAES 1, LAES 101, and LAES 201 shown in FIGS. 1, 2, and 3, respectively. In some embodiments, solar PV unit 402 can operate in a manner such as that discussed above with respect to PV apparatus 104/204. In some embodiments, solar thermal unit 408 can operate in a manner such as that discussed above with respect to solar thermal apparatus 103/203. In some embodiments, external high temperature storage unit 406 can operate in a manner such as that discussed above with respect to external high temperature storage 15/102/202. In some embodiments, battery 410 can operate in a manner such as that discussed above with respect to fast responding battery 206.

In some embodiments, controller 412 can include a processor and a memory, the memory including instructions that, when executed by the processor, cause the controller to control the operation of system 400 to regulate/stabilize the electrical capacity of energy generation of system 400, as discussed herein. For example, controller 412 can regulate/stabilize the electrical capacity of energy generation by controlling LAES unit 404 to dispatch electrical energy to consumer 414 from LAES unit 404 during periods of under capacity and to draw down electrical energy to LAES unit 404 during periods of over capacity. In some embodiments, system 400 can include more than one controller to control the operation of system 400.

In one or more embodiments of the disclosed subject matter, non-transitory computer-readable storage media and a computer processing systems can be provided. In one or more embodiments of the disclosed subject matter, non-transitory computer-readable storage media can be embodied with a sequence of programmed instructions for controlling solar power with Liquid Air Energy Storage (LAES), the sequence of programmed instructions embodied on the computer-readable storage medium causing the computer processing systems to perform one or more of the disclosed methods.

It will be appreciated that the modules, processes, systems, and devices described above can be implemented in hardware, hardware programmed by software, software instruction stored on a non-transitory computer readable medium or a combination of the above. For example, a method for controlling asymmetric energy storage systems and discharging, charging, and/or dumping therein can be implemented, for example, using a processor configured to execute a sequence of programmed instructions stored on a non-transitory computer readable medium. For example, the processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and devices can be implemented as a single processor or as a distributed processor. Further, it should be appreciated that the steps mentioned herein may be performed on a single or distributed processor (single and/or multi-core). Also, the processes, modules, and sub-modules described in the various figures of and for embodiments herein may be distributed across multiple computers or systems or may be co-located in a single processor or system. Exemplary structural embodiment alternatives suitable for implementing the modules, sections, systems, means, or processes described herein are provided below.

The modules, processes, systems, and devices described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the methods, processes, modules, devices, systems, and computer program product can be implemented in hardware and/or software using any known or later developed systems or structures, devices and/or software by those of ordinary skill in the applicable art from the function description provided herein and with a general basic knowledge of electricity generation, electricity storage systems, and/or computer programming arts.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, systems, devices, and methods for asymmetric dispatching. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention

1. A solar energy production and storage apparatus comprising:
an energy storage unit, the energy storage unit being a Liquid Air Energy Storage (LAES) unit;
a high temperature thermal storage unit;
the LAES unit comprising an electrical energy input, an electrical energy output, and one or more conduits to transfer thermal energy and/or working fluid between the LAES unit and the high temperature thermal storage unit;
a solar photovoltaic (PV) unit configured to produce electrical energy, the solar PV unit comprising an electrical energy output;
a solar thermal unit configured to produce thermal energy, the solar thermal unit comprising a thermal energy output; and
the high temperature thermal storage unit comprising a thermal energy input and one or more conduits to transfer at least one of thermal energy and/or working fluid between the LAES unit and the high temperature thermal storage unit,
wherein the electrical energy output of the LAES unit is connected to an electrical grid,
wherein the LAES unit is configured to operate in one or more modes of operation, the modes of operation comprising at least one of:
a charge or energy storage mode;
a discharge or energy production mode; and/or
an idle or non-storing non-generating energy mode,
wherein the electrical energy output of the solar PV unit is configured to be coupled to the electrical grid and/or the electrical input of the LAES unit,
wherein the electrical energy input of the LAES unit is configured to be coupled to one or more sources, the sources comprising the electrical grid and/or the electrical output of the solar PV unit,
wherein the thermal energy output of the solar thermal unit is connected to the thermal energy input of the high temperature thermal energy storage unit,
wherein the LAES unit further comprises a thermal energy input,
wherein the thermal energy output of the high temperature thermal energy unit is connected to the thermal energy input of the LAES unit, and
wherein the high temperature thermal energy storage unit is configured to operate in one or more modes of operation comprising at least one of:
a charge or thermal energy storage mode;
a discharge or thermal energy transfer mode; and/or
an idle or non-storing non-transferring thermal energy mode.

2-7. (canceled)

8. The apparatus of claim 1,
wherein the LAES unit further comprises an internal high temperature storage unit, and
wherein heat or thermal energy from the high temperature storage unit is exchangeable with the internal high temperature storage unit of the LAES unit.

9. The apparatus of claim 1,
wherein the LAES unit further comprises an expander unit,
wherein heat or thermal energy from the high temperature storage unit charges the working fluid of the LAES with high temperature thermal energy prior to entering the LAES expander unit, and
wherein the LAES unit and the high temperature storage unit are interconnected with one or more conduits to allow the passage of the working fluid.

10-11. (canceled)

12. The apparatus of claimer 1,
wherein the high temperature thermal energy storage unit further comprises a heating element unit to convert electrical energy to thermal energy,
wherein the high temperature thermal energy storage unit further comprises an electrical energy input,
wherein electrical energy is directable to the electrical energy input of the high temperature storage unit from one or more sources, the sources comprising at least one of:
the electrical grid;
the electrical output of the solar PV unit; and/or
the electrical output of the LAES unit,
wherein the high temperature thermal energy storage unit is configured to operate in one or more modes of operation, the modes of operation comprising at least one of:
a charge or thermal energy storage mode;
a thermal energy production mode;
a discharge or thermal energy transfer mode; and/or
an idle or non-storing non-transferring thermal energy mode.

13-15. (canceled)

16. The apparatus of claim 1, further comprising:
a battery unit, the battery unit comprising an electrical energy input and an electrical energy output, the electrical energy output of the battery unit being configured to be coupled to the electrical grid and/or the electrical input of the LAES unit.

17. (canceled)

18. The apparatus of claim 16, wherein the electrical energy output of the solar PV unit is configured to be coupled to:
the electrical input of the battery unit.

19-26. (canceled)

27. The apparatus of claim 16,
wherein the high temperature thermal energy storage unit further comprises an electrical energy input, and
wherein electrical energy is directable to the electrical energy input of the high temperature storage unit from one or more sources comprising at least one of:
the electrical grid;
the electrical energy output of the solar PV unit;
the electrical energy output of the LAES unit; and/or
the electrical energy output of the battery unit.

28-32. (canceled)

33. A solar energy production and storage apparatus comprising:
a solar photovoltaic (PV) unit that produces electrical energy, the solar PV unit being coupled to an energy consumer to provide electrical energy to the energy consumer;
a Liquid Air Energy Storage (LAES) unit coupled to the energy consumer to provide electrical energy to the energy consumer;
a high temperature thermal storage unit coupled to the LAES unit to transfer thermal energy to the LAES unit;
a solar thermal unit that produces thermal energy, the solar thermal unit being coupled to the high temperature thermal storage unit to transfer thermal energy to the high temperature thermal storage unit;
the high temperature thermal storage unit storing the thermal energy received from the solar thermal unit and/or passing the thermal energy received from the solar thermal unit to the LAES unit to thermally charge the LAES unit and/or to improve electrical dispatch performance of the LAES unit;
the solar PV unit and the LAES unit each coupled to the energy consumer to provide stabilized solar-LAES energy to the energy consumer; and
a controller configured to stabilize the electrical capacity of energy generation available to the energy consumer by causing the LAES unit to dispatch electrical energy to the consumer from the LAES unit during periods of under capacity and to draw down electrical energy to the LAES unit during periods of over capacity.

34. The apparatus of claim 33, the apparatus further comprising:
a battery that provides fast response electrical energy to the energy consumer while the LAES unit ramps to a predetermined load and that enters standby when the LAES unit has reached the predetermined load.

35. The apparatus of claim 34, wherein the predetermined load is substantially the full load of the LAES unit.

36. The apparatus of claim 33,
wherein the LAES unit transfers cold capacity to the solar PV unit, and
wherein the solar PV unit comprises a PV cell that is cooled down by the cold capacity of the LAES unit to increase the operating efficiency of the solar PV unit.

37. (canceled)

38. The apparatus of claim 40, wherein the LAES unit is coupled to the solar PV unit such that the LAES unit receives electrical energy generated by the solar PV unit, the electrical energy received by the LAES unit from the solar PV unit not transferred via the electric grid.

39. The apparatus of claim 33, wherein the LAES unit is coupled to an energy source to draw down electrical energy to the LAES unit from the energy source.

40. The apparatus of claim 39, wherein the energy consumer is an electric grid, and wherein the energy source is the electric grid.

41. A solar energy production and storage system, comprising:
an energy storage unit including a Liquid Air Energy Storage (LAES) unit;
a high temperature thermal storage unit;
the LAES unit comprising an electrical energy input, an electrical energy output, and one or more conduits to transfer at least one of thermal energy and working fluid between the LAES unit and the high temperature thermal storage unit;
the high temperature thermal storage unit comprising a thermal energy input connected to receive power from a non-dispatchable source of electrical power;
a thermal energy input connected to and a non-dispatchable source of thermal power, the thermal energy input being connected to the high temperature thermal storage unit to store thermal energy therein;
the thermal energy in the high temperature thermal storage unit being connected in the LAES to raise a working fluid temperature to generate electrical power at said electrical energy output.

42. The apparatus of claim 41,
wherein the electrical energy output of the LAES unit is connected to an electrical grid.

43. The apparatus of claim 41, wherein the non-dispatchable source of electrical power includes a photovoltaic (PV) unit and electrical energy output of the solar PV unit is coupled to the electrical input of the LAES unit.

44. The apparatus of claim 41,
wherein the LAES unit further comprises an internal high temperature storage unit, and
wherein heat or thermal energy from the high temperature storage unit is exchangeable with the internal high temperature storage unit of the LAES unit.

45-46. (canceled)

47. The apparatus of claim 41,
wherein the LAES unit further comprises an expander unit,
wherein heat or thermal energy from the high temperature storage unit charges the working fluid of the LAES with high temperature thermal energy prior to entering the LAES expander unit, and
wherein the LAES unit and the high temperature storage unit are interconnected with one or more conduits to allow the passage of the working fluid.

48. The apparatus of claim 41, wherein the high temperature thermal energy storage unit further comprises a heating element unit to convert electrical energy to thermal energy.
